(19) United States
(12) Patent Application Publication
(10) Pub. No.: US 2007/0146312 A1
(43) Pub. Date: Jun. 28, 2007

(54) Interactive control system

(75) Inventors: Ming-Jye Tsai, Xinpu Town (TW); Hsiang-Yu Huang, Tainan City (TW); Chi-Lianq Chen, Fengshan City (TW); Shun-Nan Liou, Kaohsiung City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/505,932

(22) Filed: Aug. 18, 2006

(30) Foreign Application Priority Data
Dec. 22, 2005 (TW) 094145780

(51) Int. Cl. G09G 5/00

(52) U.S. Cl. 345/156

(57) ABSTRACT

The present invention relates to a system for enabling a platform to interact with a user. In a preferred embodiment, data corresponding to body motions of the user is first being detected and recorded by the use of a plural inertial sensing modules, and then the recorded data of body motions is processed and converted into a control signal to be transmitted to the platform by a communication module for controlling the platform to perform movements identical or corresponding to the recorded data of body motions while enabling an image display module to emulate the recorded body motions and display the emulated images on a monitor. By the interactive control system of the invention, not only a platform can be controlled to synchronize and interact with body motions of a user in a high-precision and high-mobility fashion, but also it can provide an instant visual feedback to the user of the platform so as to enhance the interactive effect of the platform.

### FIELD OF THE INVENTION

The present invention relates to a interactive control system, and more particularly, to an interactive control platform capable of using a plurality of inertial sensors to detect a motion of a user operating the control platform for enabling the control platform to act in response to the detected motion while displaying an emulated image of the detected motion on a monitor of the control platform.

### BACKGROUND OF THE INVENTION

Conventionally, there are two methods for controlling a platform. One of which employs joysticks or switches to control actuators of a platform for forcing the platform to move forward or backward. The shortcoming of the foregoing method is that the movements of the platform can not match accurately with the directions of a user since the controllability and freedom of movement of the user are limited by that the user must hold the switches/joysticks in his/her hand. Another method programs and stores all intended operations of a platform into a hardware of a platform and uses the stored programs for controlling the platform. However, the freedom of movement of the platform is restricted since no action exceeding the range of the stored programs can be taken, not to mention to change the operations against the stored programs.

Therefore, the present invention intends to provide an interactive control platform capable of using a plurality of inertial sensors to detect a motion of a user operating the control platform for enabling the control platform to act in response to the detected motion while displaying an emulated image of the detected motion on a monitor of the control platform, such that not only the platform can be control to interact with body motions of the user in a high-precision and high-mobility fashion, but also it is more flexible comparing to prior arts since the configuration of the platform enables the same to be easily adapted for many different usages.

### SUMMARY OF THE INVENTION

It is the primary object of the present invention to provide an interactive control platform capable of using a plurality of inertial sensors to detect a motion of a user operating the control platform for enabling the control platform to act in response to the detected motion while displaying an emulated image of the detected motion on a monitor of the control platform, such that the user interacting with the platform is enabled to perform an exercise in a virtual reality surrounding simulated by the platform.

It is another object of the invention to provide a control platform capable of acting in response to the body motions of a user while providing a feedback to the user for enabling the user to response accordingly.

It is yet another object of the invention to provide a control platform capable of using an image display module to emulate and display images emulating body motions of a user and the responses of the platform corresponding thereto so as to provide an instant visual feedback to the user for enhancing the interactive effect of the platform.

To achieve the above objects, the present invention provides a system for enabling a platform to interact with a user, the system comprising: at least an inertial sensing module, a signal processing module, the platform, an image display module and an initial positioner. Wherein, each inertial sensing module is worn on the body of the user for transmitting sensing signals in a continuing manner with respect to the motion variations of the user detected thereby; the signal processing module is used to receive and process each sensing signal for issuing a first control signal and a second control signal accordingly; the platform includes at least an actuator, being actuated basing on the first control signal; the image display module is enabled to display an emulated image in response to the second control signal; the initial positioner is used to provide respectively a initial position data to each inertial sensing module and the platform, whereas the initial position data contains data of the initial position of the platform before being activated by actuators, and data of initial position of each inertial sensing module worn on the body of the user.

Preferably, the inertial sensing module further comprises at least an inertial sensor, which can be an accelerometer, a gyroscope, a leveler, or the combination thereof.

Preferably, the signal processing module further comprises a processor, an analog-to-digital converter and a communication device. The processor is used for processing sensing signals issued from each inertial sensing module. The analog-to-digital converter is used for converting signals received thereby into electrical signals. The communication device is used for transmitting the fist and the second control signals, wherein the transmitting can be accomplished by a communication cable connecting to the image display module and the platform for transmitting signals in a wire manner; or by a wireless module for transmitting signals to the image display module and the platform in a wireless manner.

Preferably, the actuator can be a linear actuator or a rotary actuator.

Preferably, the image display module further comprises a database for recording data of motions of the user's body containing in signals received thereby; wherein a recorded data is further being calibrated to be used by the image display module for displaying image emulating the recorded data and the responses of the platform corresponding thereto. Moreover, the displayed emulated image not only represents real-time motions of user's body, but also is presented with a predefined scenery matching the exercise of the user.

Preferably, each inertial sensor is capable of controlling one or more than one actuator by the first control signal corresponding to the sensing signal issued thereby; and each actuator can be controlled by the first control signals from the signal processing module corresponding to more than two inertial sensors.

Other aspects and advantages of the present invention will become apparent from the following detailed description, taken in conjunction with the accompanying, drawings, illustrating by way of example the principles of the present invention.

### BRIEF DESCRIPTION OF THE DRAWINGS

FIG. 1 is a block diagram of an interactive control system of the invention.

FIG. 2 is a schematic diagram depicting the application of the interactive control system to a surfing platform.

FIG. 3 is a schematic diagram depicting the initial positioning of a user on the surfing platform of FIG. 2.

FIG. 4 is a schematic diagram depicting a user surfing on the platform of FIG. 2.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

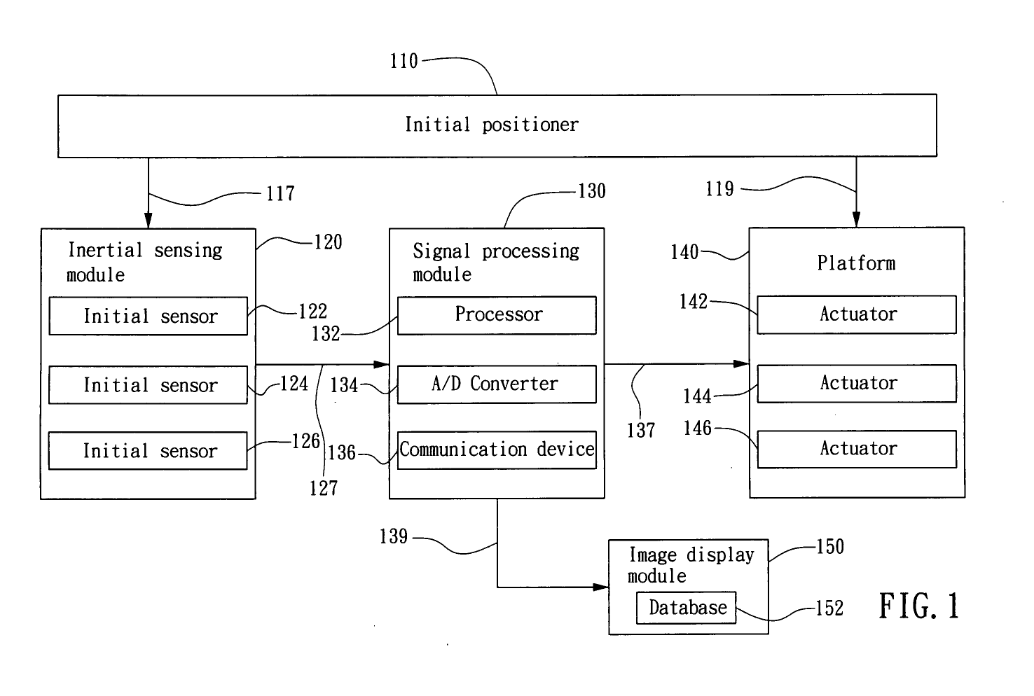

Please refer to FIG. 1, which is a block diagram of an interactive control system of the invention. The interactive control system of FIG. 1 comprises: an initial positioner 110; an inertial sensing module 120 including three inertial sensors 122, 124, 126; a signal processing module 130, further comprising a processor 132, an analog-to-digital converter 134, and a communication device 136; a platform 140, including three actuators 142, 144, 146; and an image display module 150, including a database 152.

The initial positioner 110 is used to provide signals containing initial position data 117, 119 respectively to the inertial sensing module 120 and the platform 140, so as to enable the inertial sensing module 120 and the platform 140 to recover back to their initial position, such as being positioned horizontal to the ground. Furthermore, as a user is not necessarily worn the inertial sensing module 120 by positioning the same horizontal to the ground, the initial positioner is used to set the current wearing position of the inertial sensing module 120 as horizontal. In addition, the initial positioner 110 is capable of enabling the platform 140 and the three actuators 142, 144, 146 to recover back to their initial positions for facilitating the operations of the user.

After the initial position is set, the inertial sensors 122, 124, 126 of the inertial sensing module 120 are activated to issue sensing signals 127 in a continuing manner with respect to the motion variations of the user while transmitting the some containing the corresponding motion data to the signal processing module 130. Thereafter, the signal processing module 130 uses the processor 132 to process the received sensing signal 127 and the analog-to-digital converter 134 to convert the processed signal into an electric signal, such as converting an analog signal into a digit signal. After the sensing signal 127 is received and processed by the signal processing module 130, a first control signal 137 and a second control signal 139 is generated.

The first and the second control signals 137, 139 are then being transmitted out of the signal processing module 130 respectively to the platform 140 and the image display module 150 by the communication device 136 in a wired or wireless manner, that is, the two control signals 137, 139 can be transmitted by way of a signal cable or by a built-in RF transmitter to be received by a RF receiver using the same communication protocol. As the first control signal 137 is received by the platform 140, the three actuators 142, 144, 146 are activated. As the second control signal 139 is received by the image display module 150, the received signal is compared with the data of human body motions stored in the built-in database 152 for enabling the image display module to display images emulating the motion data containing in the received second control signal 139 and the responses of the platform 140 corresponding thereto.

The interactive control system shown in FIG. 1 is only a embodiment of the invention, wherein the number of the inertial sensing module is not limited thereby to only one inertial sensing module, moreover, the number and the positioning of the inertial sensors also is not limited by the embodiment of FIG. 1. In addition, the inertial sensor can be a accelerometer, a gyroscope, a leveler or any other detector capable of detecting human motions; the actuator can be a valve, a motor, a switch, a linear actuator, a rotary actuator or any other mechanical devices capable of forcing a movement. It is noted that there are certain pairing relationship between inertial sensors and actuators, which is not necessary to be one-on-one. For instance, each inertial sensor is capable of controlling one or more than one actuator by the first control signal corresponding to the sensing signal issued thereby; or each actuator can be controlled by the first control signals from the signal processing module corresponding to more than two inertial sensors.

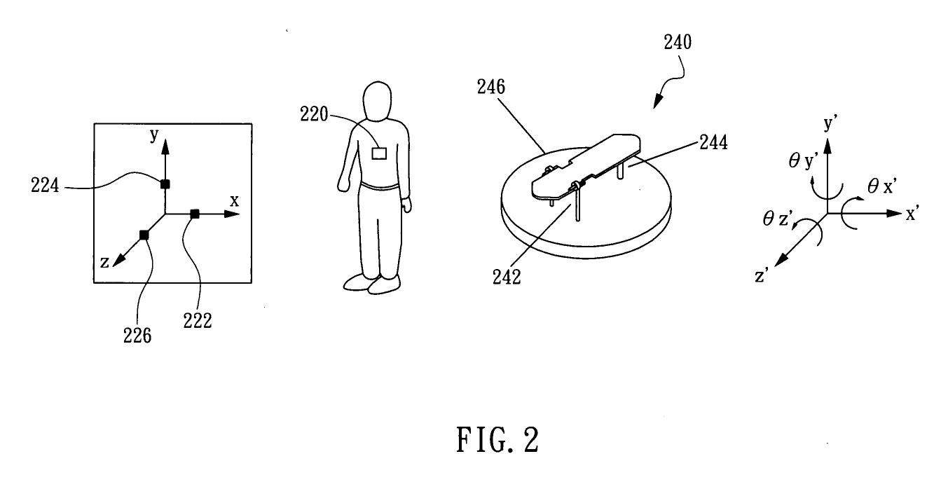

Please refer to FIG. 2, which is a schematic diagram depicting the application of the interactive control system to a surfing platform. For enabling the interactive control system to emulate surfing gestures of a user, an inertial sensing module 220 is attached on the proper position of the user's body so as to enable the three inertial sensors 222, 224, 226 built in the inertial sensing module 220 to detect data of motion respectively along X-axis, Y-axis and Z-axis, the data including power, displacement, velocity, or acceleration, etc. Moreover, as seen in FIG. 2, there are two linear actuators 242, 244 and a rotary actuator 246 arranged in the platform 240, whereas the linear actuator 242 is responsible for emulating the motions along the Θx′ direction, and the linear actuator 244 is responsible for emulating the motions along the Θz′ direction, and the rotary actuator 246 is responsible for emulating the motions along the Θy′ direction.

The two actuators 242, 244 and the rotary actuator 246 are directed to operate according to the control signals issued by a signal processing module (not shown in FIG. 2), whereas the control signals respectively being used to control the two actuators 242, 244 and the rotary actuator 246 to operate are sensing signals respectively received from the three inertial sensors 222, 224, 226 after being processed.

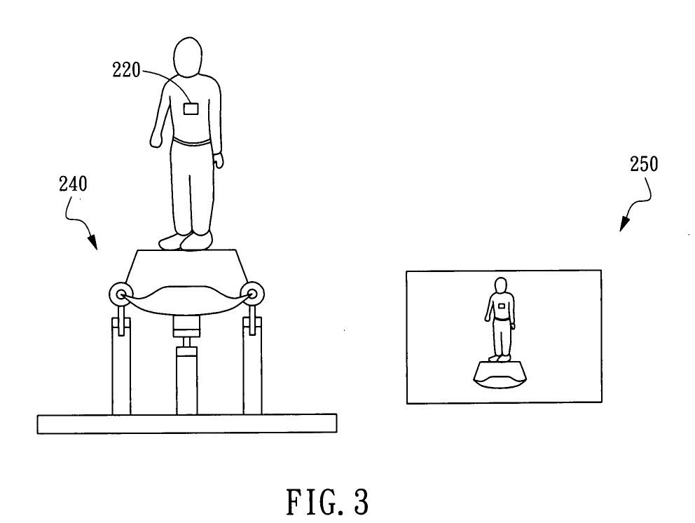

Please refer to FIG. 3, which is a schematic diagram depicting the initial positioning of a user on the surfing platform of FIG. 2. In FIG. 3, as the inertial sensing module 220 is worn on a user, an inertial positioner (not shown in FIG. 3) is activated for enabling the inertial sensing module 220 and the platform 240 to recover back to their predefined initial position while the image display module 250 display a user in his/her initial position.

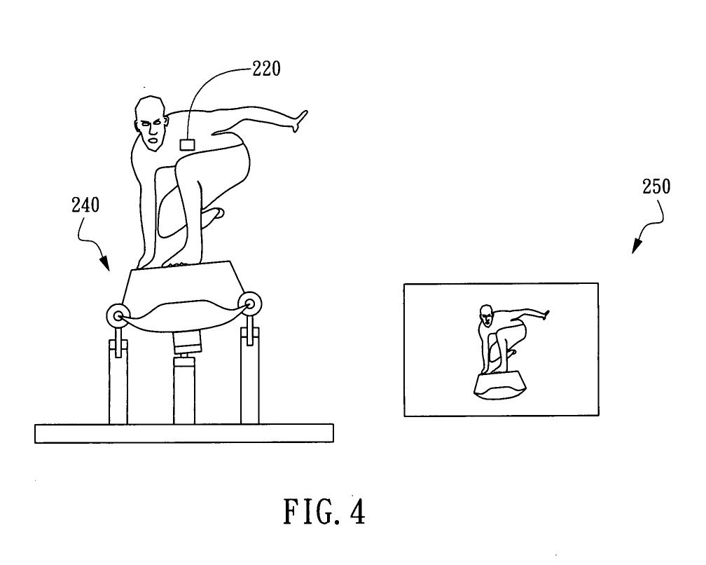

Please refer to FIG. 4, which is a schematic diagram depicting a user surfing on the platform of FIG. 2. As the user starts surfing on the platform 240, the platform 240 is activating in response to the motions of the user while the inertial sensing module 220 detects and sends sensing signals containing surfing motion data to the signal processing module 230 to be processed thereby for enabling the signal processing module 230 to issue control signals to the platform 240 and the image display module 250, such that the image display module 250 is enabled to display images emulating the surfing motion data containing in the received control signal and the responses of the platform 240 corresponding thereto. In addition, the displayed emulated image not only represents real-time surfing motions of the user's body, but also is presented with a predefined scenery matching the surfing of the user, e.g. an ocean with waves, such that the user can surf as if he/she is really surfing in ocean.

To sum up, the present invention provides a system for enabling a platform to interact with a user, by which data corresponding to body motions of the user is first being detected and recorded by the use of a plural inertial sensing modules, and then the recorded data of body motions is processed and converted into a control signal to be transmitted to the platform by a communication module for controlling the platform to perform movements identical or corresponding to the recorded data of body motions while enabling an image display module to emulate the recorded body motions and display the emulated images on a monitor. By the interactive control system of the invention, not only a platform can be controlled to synchronize and interact with body motions of a user in a high-precision and high-mobility fashion, but also it can provide an instant visual feedback to the user of the platform so as to enhance the interactive effect of the platform.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An interactive control system, comprising:
at least an inertial sensing module, each being worn on human body for transmitting sensing signals in a continuing manner with respect to the motion variations of the human body detected thereby;
a signal processing module, being used to receive and process each sensing signal for issuing a first control signal and a second control signal accordingly;
a platform, further comprising at least an actuator, each being actuated in response to the first control signal;
an image display module, being enabled to display an emulated image in response to the second control signal; and
an initial positioner, being used to provide a initial position data respectively to each inertial sensing module and the platform.

2. The interactive control system of claim 1, wherein the inertial sensing module further comprises at least an inertial sensor.

3. The interactive control system of claim 2, wherein the inertial sensor is an accelerometer.

4. The interactive control system of claim 2, wherein the inertial sensor is gyroscope.

5. The interactive control system of claim 2, wherein the inertial sensor is a leveler.

6. The interactive control system of claim 1, wherein the signal processor further, comprising:
a processor, for processing sensing signals issued from each inertial sensing module.

7. The interactive control system of claim 1, wherein the signal processor further comprises: an analog-to-digital converter.

8. The interactive control system of claim 1, wherein the signal processor further, comprising:
a communication device, for transmitting the fist and the second control signals.

9. The interactive control system of claim 8, wherein the communication device is connected to the image display module by a cable.

10. The interactive control system of claim 8, wherein the communication device is connected to the platform by a cable.

11. The interactive control system of claim 8, wherein the communication device is enabled with a wireless communication ability.

12. The interactive control system of claim 1, wherein the image display module further comprises a database for recording motion data of the human body.

13. The interactive control system of claim 1, wherein the actuator is a linear actuator.

14. The interactive control system of claim 1, wherein the actuator is a rotary actuator.

15. The interactive control system of claim 1, wherein the emulated images displayed by the image display module are capable of representing real-time motions of the human body.

16. The interactive control system of claim 1, wherein the emulated images displayed by the image display module are presented with a predefined scenery.

17. The interactive control system of claim 1, wherein the initial position data contains data of the initial position of the, platform before being activated by actuator.

18. The interactive control system of claim 1, wherein the initial position data contains data of initial position of each inertial sensing module worn on the human body.

19. The interactive control system of claim 2, wherein each inertial sensor is capable of controlling at least one actuator by the first control signal corresponding to the sensing signal issued thereby.

20. The interactive control system of claim 2, wherein each actuator can be controlled by the first control signals from the signal processing module corresponding to at least two inertial sensors.
